(19) United States
(12) Patent Application Publication
(10) Pub. No.: US 2006/0149726 A1
(43) Pub. Date: Jul. 6, 2006

(54) Segmentation of web pages

(76) Inventors: Thomas Ziegert, Darmstadt (DE); Axel Spriestersbach, Karlsruhe (DE)

Correspondence Address: PERKINS COIE LLP, 101 JEFFERSON DR, PO BOX 2168, MENLO PARK, CA, 94025, US

(21) Appl. No.: 11/027,721

(22) Filed: Dec. 30, 2004

(51) Int. Cl. G06F 17/30

(52) U.S. Cl. 707/5

(57) ABSTRACT

A system and method for segmentation of web pages is provided. In one embodiment, the invention is a method. The method includes receiving a request for a web page. The method also includes splitting the web page into displayable sections. The method further includes serving a first section of the web page. The method may also include serving a second section of the web page. The method may further include weighting content of the web page. Also, the method may involve content weighted based on a heuristic. Similarly, the method may include content weighted based on a profile for a target device. Additionally, the method may involve the profile for the target device being supplied by a manufacturer. Moreover, the method may involve content weighted based on information from a target device. Similarly, the method may involve querying the target device for information.

### CROSS-REFERENCE TO RELATED APPLICATION

None

### TECHNICAL FIELD

The present application generally relates to the field of web page software, and more specifically to service of web pages.

### BACKGROUND

Web pages may be viewed by many users of the world wide web and other web systems (e.g. intrawebs). Viewing of web pages traditionally occurs on computer systems or terminals with relatively large displays and seemingly unlimited data storage resources—a web page with complicated graphics and much text may be stored locally and scrolled through. However, other devices may also be used for web page viewing.

Cellular telephones, personal digital assistants, two-way pagers or email terminals and digital music players may all potentially be used to view web pages, along with countless other devices. However, such devices typically have limited memory and small displays—they are small devices. A web page with large memory-consuming graphics may overwhelm the device. Moreover, a web page with much text or many fields for data entry may simply not be displayable on the small display (and may overwhelm memory, too). Thus, it may be useful to display only parts of a web page at a time.

FIG. 1 illustrates an embodiment of a system for serving a web page. System 100 includes a web server, a proxy server, and a receiving device which splits web pages for display. Such a system may be used to display web pages or similar material on small devices such as cellular telephones, personal digital assistants and personal music players (e.g. iPods™ available from Apple Computer of Sunnyvale, Calif.) for example.

Web server 110 may be a server such as a software process or a separate hardware server, or may be a repository of web pages. Proxy server 120 is a proxy server which transmits web pages to small devices, such as device 140. Typically, the proxy server 120 receives web pages from web server 110, either from a server or from a web page repository embodied as web server 110. Proxy server 120 then attempts to serve the web page to device 140 (a target device).

However, device 140 is typically a device with a small display and limited memory, so a traditional web page may not be displayable. Split module 130, part of device 140, receives the web page data and determines what can be displayed. Split module 130 then notifies proxy server 120 that it cannot display the entire web page, and later requests the rest of the web page in order to display the next section of the web page. This may iteratively occur multiple times for web pages, until an entire web page is displayed on the device. However, this process involves significant delays, repetitive transfers of data over scarce transmission resources, and often involves splitting images on a web page which would be better displayed without breaks. Thus, it may be useful to display web pages on devices with limited resources and/or displays, and avoid some of the bandwidth problems and resource problems of the above approach.

One may think of a webpage as an authoring unit (AU). Preferably, the AU is of a size which may be reasonably displayed on a receiving device. However, with small devices, this may not be true. For example, an AU sized for use with a desktop or laptop computer may contain far more information and be rendered into far more pixels than can reasonably be handled by a small device. Thus, it may be useful to handle large-size AUs for small devices.

### SUMMARY

A system and method for segmentation of web pages is provided. In one embodiment, the invention is a method. The method includes receiving a request for a web page. The method also includes splitting the web page into displayable sections. The method further includes serving a first section of the web page. The method may also include serving a second section of the web page. The method may further include weighting content of the web page. Also, the method may involve content weighted based on a heuristic. Similarly, the method may include content weighted based on a profile for a target device. Additionally, the method may involve the profile for the target device being supplied by a manufacturer. Moreover, the method may involve content weighted based on information from a target device. Similarly, the method may involve querying the target device for information.

The method may also involve the first section of the web page including sticky content for use with all sections of the web page. The method may further involve receiving data from a target device. The method may additionally involve storing data from the target device as aggregate data. The method may also involve transmitting aggregate data from the target device. The method may further involve weighting content of the web page based on an expected display size of data of the web page.

In an alternate embodiment, the invention is a system. The system includes a page weighting module. The system also includes a page splitting module. The system further includes a proxy server. The system may also include means for serving web pages to a proxy server.

In another alternate embodiment, the invention is a method. The method includes receiving a section of a web page. The method also includes displaying the section of the web page. The method may further include querying for a next section of the web page. The method may also include querying for a next web page. The method may further include receiving data from a user responsive to the web page and transmitting the data to a server.

Methods of the embodiments may be performed by a processor responsive to execution by the processor of a set of instructions, with the instructions embodied in a machine-readable medium. The invention may also be a machine-readable medium embodying instructions, which, when executed by a processor, cause the processor to perform the method, in some embodiments.

It will be appreciated that the present invention is described below using specific examples that are not intended to limit the invention. The systems and methodology may be applied to a broad range of other computer applications. Therefore these and other advantages and aspects of the present invention will become apparent to those skilled in the art upon a reading of the following detailed description and a study of the drawing figures.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims.

FIG. 1 illustrates an embodiment of a system for serving a web page.

FIG. 2 illustrates an alternate embodiment of a system for serving a web page.

FIG. 3 illustrates an embodiment of a method of serving a web page.

FIG. 4 illustrates an alternate embodiment of a method of serving a web page.

FIG. 5A illustrates how a web page may be segmented in one embodiment.

FIG. 5B illustrates how another web page may be segmented in one embodiment.

FIG. 6A illustrates a web page in one embodiment.

FIG. 6B illustrates an option for segmenting a web page in one embodiment.

FIG. 6C illustrates another option for segmenting a web page in one embodiment.

FIG. 6D illustrates yet another option for segmenting a web page in one embodiment.

FIG. 7 illustrates an embodiment of a system or network of machines over which web pages and data may be transmitted.

FIG. 8 illustrates an embodiment of a system or machine which may be used to store, transmit or view web pages.

FIG. 9 illustrates an embodiment of a system or medium for segmenting a web page.

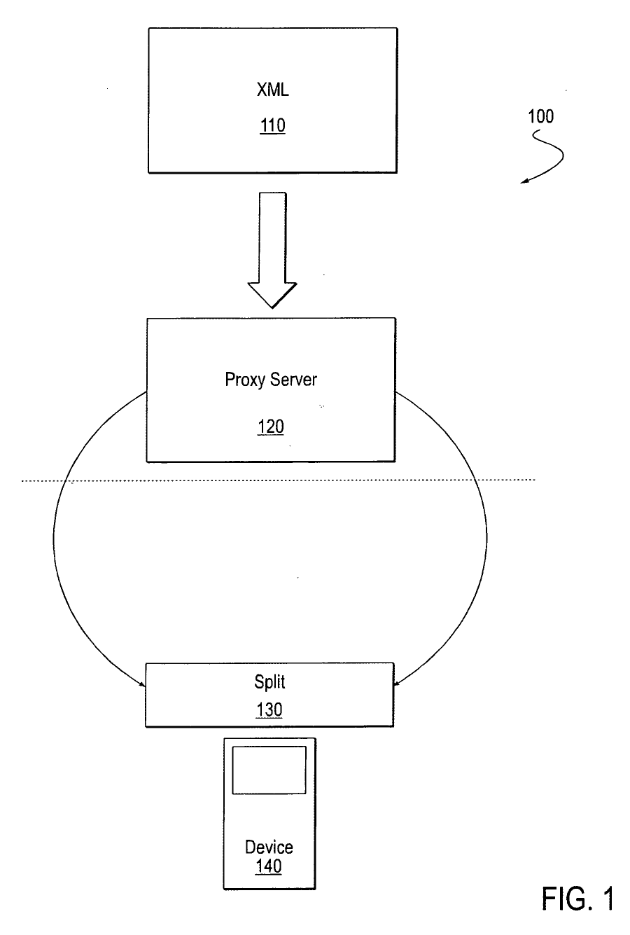

### DETAILED DESCRIPTION

A system and method for segmentation of web pages is provided. The invention may be implemented as a method, an apparatus, or a system. In general, one may expect that web pages will be split at a server level for specific devices. In doing so, one may limit resource requirements for target devices. Moreover, one may minimize or reduce bandwidth requirements for web page transmission. Additionally, one may establish rules for when breaks in web pages may occur, allowing for grouping of important subject matter, for example.

In one embodiment, the invention is a method. The method includes receiving a request for a web page. The method also includes splitting the web page into displayable sections. The method further includes serving a first section of the web page. The method may also include serving a second section of the web page. The method may further include weighting content of the web page. Also, the method may involve content weighted based on a heuristic. Similarly, the method may include content weighted based on a profile for a target device. Additionally, the method may involve the profile for the target device being supplied by a manufacturer. Moreover, the method may involve content weighted based on information from a target device. Similarly, the method may involve querying the target device for information.

The method may also involve the first section of the web page including sticky content for use with all sections of the web page. The method may further involve receiving data from a target device. The method may additionally involve storing data from the target device as aggregate data. The method may also involve transmitting aggregate data from the target device. The method may further involve weighting content of the web page based on an expected display size of data of the web page.

In an alternate embodiment, the invention is a system. The system includes a page weighting module. The system also includes a page splitting module. The system further includes a proxy server. The system may also include means for serving web pages to a proxy server.

In another alternate embodiment, the invention is a method. The method includes receiving a section of a web page. The method also includes displaying the section of the web page. The method may further include querying for a next section of the web page. The method may also include querying for a next web page. The method may further include receiving data from a user responsive to the web page and transmitting the data to a server.

In still another embodiment, the invention is a method. The method includes receiving a request for a web page from a device having a small display. Also, the method includes splitting the web page into sections at a server. The sections are both displayable by the device and transmittable in one transmission to the device. Moreover, the method includes serving a first section of the web page to the device having the small display. The method may also include features described with respect to other methods described in this document.

In yet another embodiment, the invention is a method of processing web data on a small device. The method include receiving a section of a web page from a server. The section is sized to be both displayable on the small device and transmittable in one transmission to the small device. The method also includes displaying the section of the web page on a small display of the small device. The method may also include features described with respect to other methods described in this document and of related embodiments.

In another embodiment, the invention is a system. The system includes a page weighting module. The page weighting module is to weight content of a web page. Additionally, the system includes a page splitting module. The page splitting module is to split the web page based on display limits and transmission limits of a small device. Further, the system includes a proxy server. The system may include features described with respect to other systems, devices or methods of this document and related embodiments.

Methods of the embodiments may be performed by a processor responsive to execution by the processor of a set of instructions, with the instructions embodied in a machine-readable medium. The invention may also be a machine-readable medium embodying instructions, which, when executed by a processor, cause the processor to perform the method, in some embodiments. Moreover, methods of the invention may, in various embodiments, use features or aspects of multiple different embodiments described herein. Similarly, apparatus or systems of the invention may, in some embodiments, use features or aspects of multiple different embodiments even though the specific combination of such features is not explicitly described in a single embodiment herein.

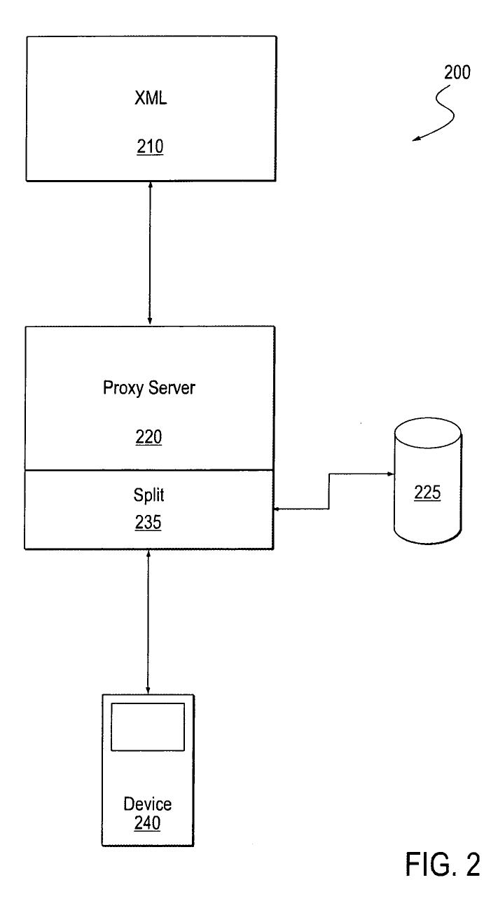

Various systems and methods may be used to implement a web page splitting mechanism. FIG. 2 illustrates an alternate embodiment of a system for serving a web page. System 200 includes a web server, a proxy server with a split module, and a receiving device. Such a system may be used to display web pages or similar material on small target devices such as cellular telephones, personal digital assistants and personal music players (e.g. iPods™ available from Apple Computer of Sunnyvale, Calif.) for example.

Web server 210 may be a server such as a software process or a hardware server, or a repository of web pages for example. Ultimately web server 210 serves as a source of web pages. Proxy server 220 is a proxy server which transmits web pages to small devices, such as device 240. Proxy server 220 includes or is combined with split module 235. Typically, the proxy server 220 receives web pages from web server 210, either from a server or from a web page repository embodied as web server 210. Proxy server 220 then attempts to serve the web page to device 240.

Split module 235 is employed to split the web page at the server level into pages which are expected to be displayable by the device 240. Split module 235 may be expected to weight the content of the web page based on expected display capabilities of device 240. Such display capabilities may be retrieved from, for example, data repository 225. Thus, data repository 225 may include information expected to define display capabilities of device 240, such as height and width of screen in pixels, for example. Data repository 225, in some embodiments, may include heuristics, sets of rules generally applicable to various devices. Data repository 225, in alternate embodiments, may include manufacturer specifications for devices which may be used in conjunction with information received from device 240 responsive to a query. In yet other embodiments, data repository 225 may include specifications registered to a specific user for device 240.

Split module 235 may use a size delta as a screen size for device 240, and split data from the web page into units of size delta based on expected rendering capabilities of device 240. These delta size units may then be served individually to device 240 in a sequence determined based on user input to device 240. Thus, web page data may be served on demand, without necessarily overwhelming memory available in device 240 or bandwidth available in the connection to device 240. Note that device 240 may include an internal split module as well, which may split data at device 240 further. However, by serving data in portions sufficient for display on device 240, such device-level splitting should be relatively infrequent, and based more on rendering into larger than expected displays, rather than on overwhelming memory availability for example.

Some content will likely not be amenable to splitting as well as other content. For example, a large JPEG image, for example, may not split well. Various methods may be used to handle splitting such an image. Weighting of web page data in general is discussed further below, but it may function by weighting XML data based on expected rendering size, and attempting to keep related parts of such data in a single portion of a web page when the portions of the web page are divided and served. Thus, text may be expected to be kept whole, rather than having words split horizontally or vertically for example. Similarly, groups of text (e.g. a small set of bulleted items or a table) may be served together (even in a slightly oversized portion, for example), rather than splitting up the grouped text among two or more portions.

Split module 235 may also be used for another aspect of splitting. When a form is split, data may be entered into part of a form responsive to a first portion of a web page being served, and then data may be entered into another part of the form responsive to a second portion of the web page being served. However, an originating web server (or proxy server) need not know the web page was ever split. To achieve this, split module 235 may receive data from device 240 responsive to portions of a web page, and then transfer that data in bundled form once all data is received responsive to all portions of a web page. Signaling that all data has been received may occur as a result of a response to a last portion of a web page, use of a submit button or similar user interface feature, or access requests for a separate web page (instead of a next portion for example). Other signals may be envisioned as well.

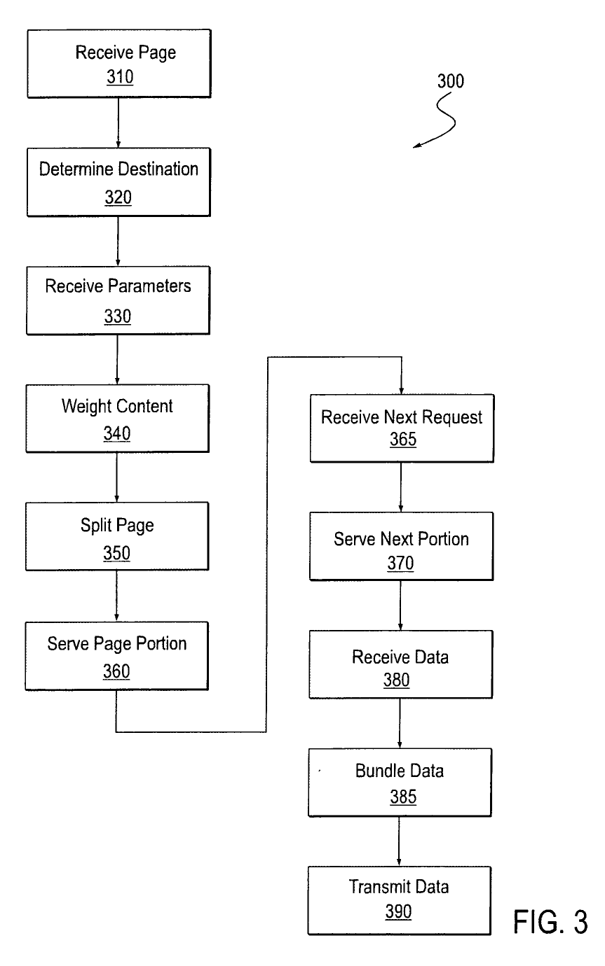

Various methods of splitting a web page may be used, either in conjunction with systems such as system 200 or with other systems (such as system 800 for example). FIG. 3 illustrates an embodiment of a method of serving a web page. Process 300 includes receiving a web page, weighting content of a page, determining a destination, splitting a page based on parameters for the destination, serving portions of the page, receiving responsive data, and transmitting the responsive data to a data destination. Process 300 may be implemented and understood as a set of modules, as may all processes described and illustrated herein. Process 300 and all processes described herein may be rearranged, reordered, modules may be combined or subdivided, and modules may be executed in a parallel or serial fashion within the scope of the present invention.

Process 300 begins with receipt of a web page (such as from a web server or a file) at module 310. The web page may be thought of as an AU or authoring unit. At module 320, a destination for the content is determined, such as a cellular telephone, two-way pager, personal digital assistant, digital music player, or other target device for example. Parameters for that device are then received at module 330, such as from a repository, or from a response to a query to the device for example. Note that a destination may be assumed or may be looked up, depending on resources available to various embodiments, for example. From the device, a size delta for the device may be derived, and this size delta is the parameter which is retrieved (potentially with others). Thus, an AU may be split up into delta-sized presentation units (PU) which will collectively convey the information of the AU but be displayable on the small device as PUs. Note that a delta-sized PU may be sized based on display characteristics, or bandwidth/transmission characteristics. Thus, delta may be set for a device based on expected bandwidth, rather than display size.

At module 340, content is weighted based on the number of pixels it will occupy (both height and width) when it is rendered. Such weighting may indicate which parts of a web page, represented in XML for example, should be kept together and which parts may be separated. Extensions to XML/HTML may allow for designation of material as splitable or as non-splitable (grouped or locked for example) through attributes for example. Moreover, such weighting may attach an indication of size to otherwise unrendered XML code and corresponding data.

For weighting purposes, mark-up elements may be divided into several categories: basic elements with content-dependent size, basic elements with content-independent size and compound elements formed from a set of one or more basic elements. Examples of content-dependent basic elements are:
<p>, <b>, <br>, <h1> . . . <h6> in XHTML
<trigger>, <submit>, <label>, <value>, <alert> for Xforms form controls
<navigation-link> for IML navigation

Each of these elements may be expected to take up a certain area on a screen, for example, when rendered by a browser as a browser-specific counterpart on a particular small device. The space required may be estimated as a weight (w) of an element (e) of a type (i), computed as:
w(eᵢ)=c(eᵢ)fᵢ

with c denoting a content count which is the number of content units (delta) in a tag (e.g. characters in a <p> tag for example) and ƒᵢ denoting an element type and device specific factor related to the element or tag itself For example, a <p> tag usually involves some space before and after the paragraph so tagged, and such space should be considered in the weighting.

Content-independent basic elements may be those elements which specify a size of the element (e.g. images) or those elements which have a default value for the specific device. Examples of content-independent basic elements include:
<object> (for images) in XHTML and
<input> and <textarea> for XForms 1.0 form controls.
   For images, for example, the width and height in pixels are related to delta (available screen surface for example). For <input> or <textarea> for example, the device parameters of module 330 may provide default values or information (e.g. fontsize) from which to calculate a default value.

For compound elements, summing the weights of the corresponding basic elements (and included compound elements) provides a weight for the compound element. Compound elements include <o1> and <table> in XHTML, and <select1> in XForms 1.0 for example. A weighting for an <o1> compound element may be derived from:

$$w ( {e}_{i} ) = {\sum }_{j} w ( {e}_{j} ) {f}_{spc}$$

w(eⱼ) is the weight of particular list items eⱼ, j is the number of list items in <o1>, f_{spc} is the overhead for the list, such as spacing between list items.

A weighting for a <select1> item may similarly be derived from:

$$w ( {e}_{i} ) = {f}_{tbl} w ( {e}_{i} ) + {f}_{il} {\sum }_{j} w ( {e}_{j} ) + {f}_{itm} {\sum }_{k} w ( {e}_{k} )$$

f_{tbl}, fᵢₗ and fᵢₜₘ are factors for the label, item label and item weights, respectively. w(eᵢ), w(eⱼ) and w(eₖ) are the respective element type specific weights. Thus, the specific elements of the <select1> statement are weighted differently, yet the label and value weights are basic elements calculated as before.

Note that content weighting has been described typically with respect to weighting for display size constraints. However, for some devices, the limitation is related to transmission bandwidth rather than display size. A small device with a large display and a tiny transmission and reception channel (e.g. small bandwidth) may perform admirably on data stored on the device, but take an unreasonable amount of time to receive data sufficient to fill a screen with data from a web page. In such situations, the parameters for the device may dictate a smaller delta than the small screen size requires, for transmission purposes. For example, in some devices, a size delta may be based on the size for one transmission burst (such as a packet or set of packets for example). This transmission burst may be based on known or observed characteristics of the transmission network and the device, for example. Understandably, some combination of display size constraints and transmission bandwidth constraints may lead to the value delta specified for a device, such that the same device on different networks may operate with a different value delta, depending on transmission capabilities, for example.

At module 350 of method 300, the page is then split by taking delta-sized (approximately) portions of the web page based on weighted content. Again, delta may be expected to be an approximate size of an available display for the target device. Such size may actually vary due to model variations, additional software, or other factors. The weight of the portion or section may be expressed as:

$$w ( {e}_{i} ) = {f}_{sws} {\sum }_{j} w ( {e}_{j} )$$

Or the weight of the section may be described as the sum of the weights of the items j of the section multiplied by (or potentially added to) a factor for neglected whitespace within the section. The weight w(eᵢ) is compared to delta to ensure the section or portion is of appropriate size.

With the split pages prepared, a first portion of the web page is served to the device at module 360. At module 365, a request from the device for the next portion of the web page is received. In response, the next portion of the web page is served at module 370. At module 380, data is received in response to the latest portion of the web page served. At module 385, that data is bundled with other data received responsive to other portions of the web page, and at module 390, the bundled data is passed back to the origin of the web page or any listening process as if the web page was served all at once.

As may be expected, a loop of modules 365 and 370 (not shown) may be expected to form, as multiple next portions of the web page are requested in sequence. Such a loop may result in multiple instances of data received as in module 380, thus requiring the bundling of module 385 prior to the transmission of data of module 390. Moreover, even with web page data served in portions based on expected rendered size and expected rendering capabilities, actual rendering at the target device may differ from expectations, requiring some scrolling or additional processing at the target device. However, it may be expected that most data will fit in the display area available, and most data will also fit within the memory available.

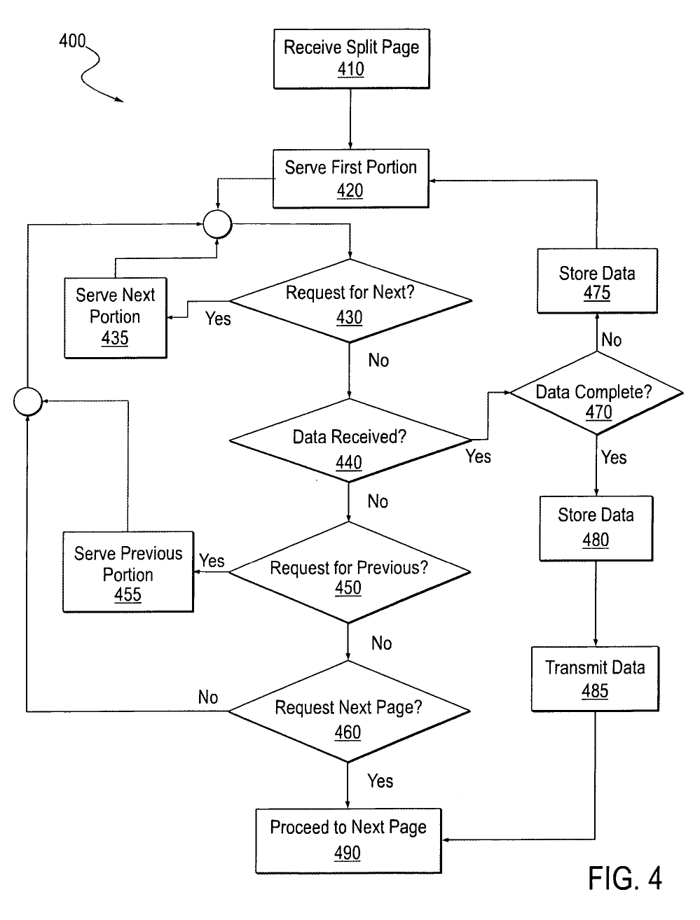

Other methods of splitting a web page may also be used, either in conjunction with systems such as system 200 or with other systems (such as system 800 for example). FIG. 4 illustrates an alternate embodiment of a method of serving a web page. Process 400 includes receipt of a split web page, serving a first portion, serving additional portions and previous portions, receiving and storing data, transmitting complete data, and providing a next page. Thus, process 400 describes a process relating to serving web page data which is already split. Such as process may be substituted into portions or process 300, for example.

Process 400 begins with receipt of a split web page at module 410. A first portion of the web page is served at module 420. At module 430, a determination is made as to whether a next portion of the web page has been received. If yes, the next portion of the web page is served at module 435 and the process returns to module 430. If no, a determination is made at module 440 as to whether data has been received. If so, at module 470, a determination is made as to whether the received data is complete, or completes data received from the web page, either due to the last field being filled or due to a submit button or similar feature being activated. If the data is incomplete, the received data is stored at module 475 and the process returns to module 430. If the data is complete, the data is stored at module 480, and the complete set of data (all stored data for the web page) is transmitted or passed along at module 485.

If a request for next portion was not received at module 430 and data was not received at module 440, a determination is made at module 450 as to whether a request for the previous portion of the web page was received. If so, then at module 455, the previous portion of the web page is served again (presumably the target device did not retain it) and the process returns to module 430. If the determination at module 450 is that no request for the previous portion was received, then a determination is made at module 460 as to whether a request for a next web page (or different web page) was received. If so, at module 490, the next (or requested) web page is served. If not, the process returns to module 430.

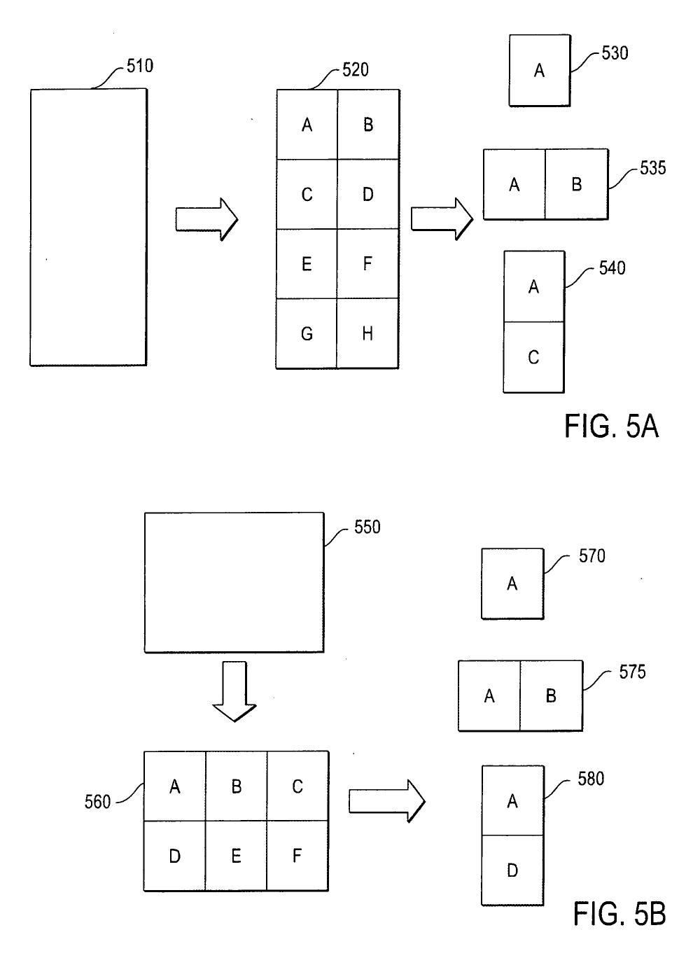

Segmentation of web pages, as achieved by system 200 or process 300 for example, may result in various different web page forms. FIG. 5A illustrates how a web page may be segmented in one embodiment. Web page 510 is a web page as it may be rendered on a display without regard to size or memory limitations. This is not to say web page 510 is actually rendered, so much as it represents the web page. Web page 520 is a segmented web page, with segments A-H shown. Such segmentation may be based on a size delta which is expected for a target device, or may be a weighted set of data which has segments smaller than expected portions for some target devices. In some embodiments, segments A-H will be sized for the smallest target device available, for example. In other embodiments, segments A-H may represent portions of segments for devices with larger display areas. Web page 530 is a first portion for a target device for which the size delta corresponds to a single segment (roughly). Web page 535 is a first segment for a target device for which two side-by-side portions may be fit into the corresponding size delta. Web page 540 is a first segment for a target device for which two vertically arranged portions may be fit into the corresponding size delta.

Segmentation, as achieved by system 200 or process 300 for example, may be different for other web pages. FIG. 5B illustrates how another web page may be segmented in one embodiment. Web page 550 is a web page as it may be rendered on a display without regard to size or memory limitations. Web page 550 may represent a different orientation (relative to web page 510) for which a web page is designed, for example. Web page 560 is a segmented web page, with segments A-F shown. Again, such segmentation may be based on a size delta which is expected for a target device, or may be a weighted set of data which has segments smaller than expected portions for some target devices. In some embodiments, segments A-F may be determined based on serving web pages horizontally first, and then vertically, for example, though other service orders may be appropriate. In particular, internationalization may result in right-to-left service, for example. Moreover, A-F may represent portions of a webpage when the segments are larger than individual portions. Web page 570 is a first portion for a target device for which the size delta corresponds to a single segment (roughly). Web page 575 is a first segment for a target device for which two side-by-side portions may be fit into the corresponding size delta. Web page 580 is a first segment for a target device for which two vertically arranged portions may be fit into the corresponding size delta.

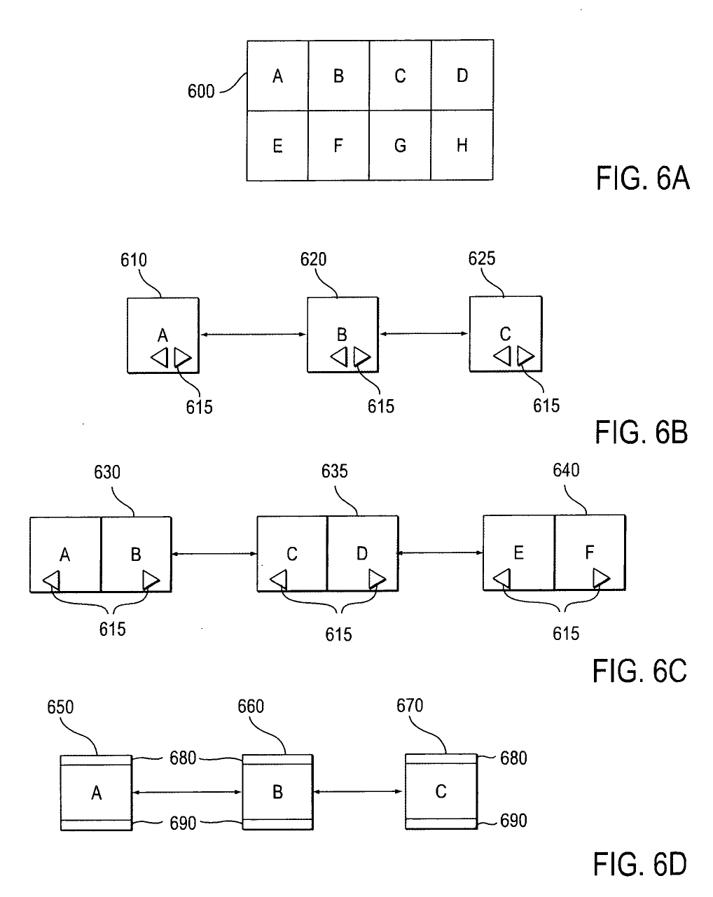

Navigation between segments or portions of a web page may be achieved in a variety of ways, and display of such portions may have various forms. FIG. 6A illustrates a web page in one embodiment. Web page 600 is segmented into segments A-H. FIG. 6B illustrates an option for segmenting a web page in one embodiment. Each of segments A (610) B (620) and C (625) include navigation icons 615 which allow for navigation from one segment (e.g. first portion) to another segment (e.g. second portion). FIG. 6C illustrates another option for segmenting a web page in one embodiment. Portions 630, 635 and 640 each include two segments. Here, the navigation icons 615 are illustrated as separate, but various navigation icons may be used. Moreover, here, navigation from a first portion 630 to a second portion 635 may involve switching from segments A and B to segments C and D, for example. Note that navigation is restricted in such embodiments to previous or next portions, without random access to various portions of the web page. One may implement some form of a map allowing for navigation randomly within a web page, but this may also be disadvantageous, as a user may click on the wrong segment in a map and get lost in the web page, for example.

FIG. 6D illustrates yet another option for segmenting a web page in one embodiment. Rather than showing navigation icons, banners or frames are illustrated. A web page may be served, with the expectation that it will only be allocated part of a screen, rather than a full display. Portions 650, 660 and 670 may be served as including segments A, B and C respectively, along with border material 680 and 690 on each page. Alternatively, segments A, B and C may be served as the portions of the web page, with space reserved for locally created material 680 and 690. Space 680 may be a header or menu bar (or advertisement for example). Space 690 may similarly be a status bar, task bar or advertisement, or other dedicated part of the display. Also, spaces 680 and 690 may be used as navigation aids, too.

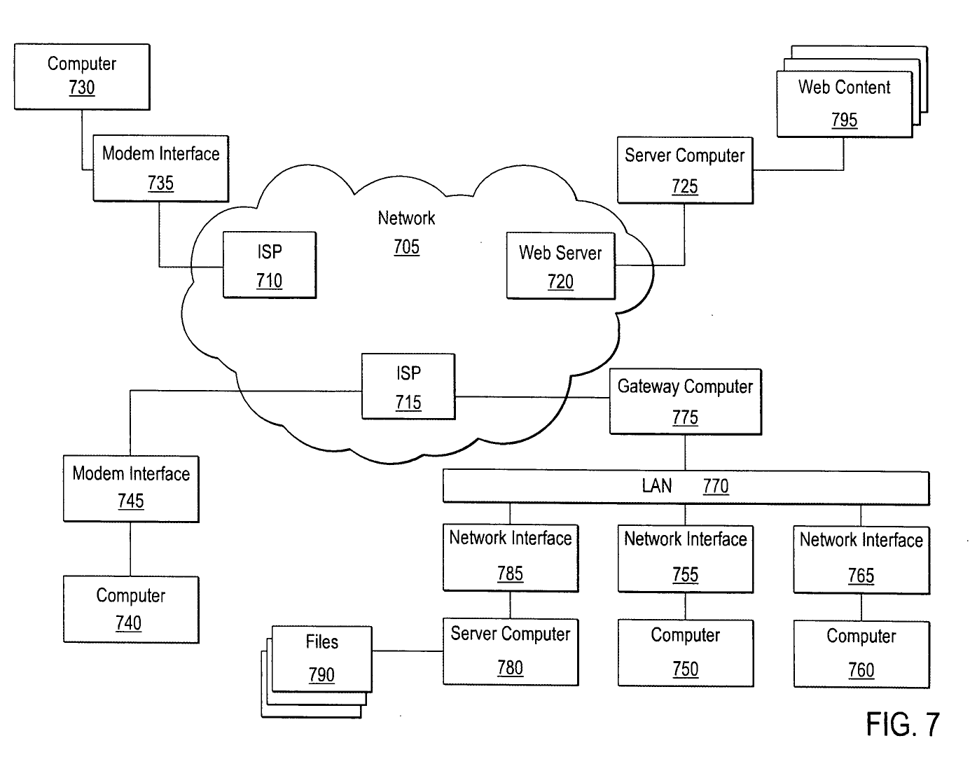

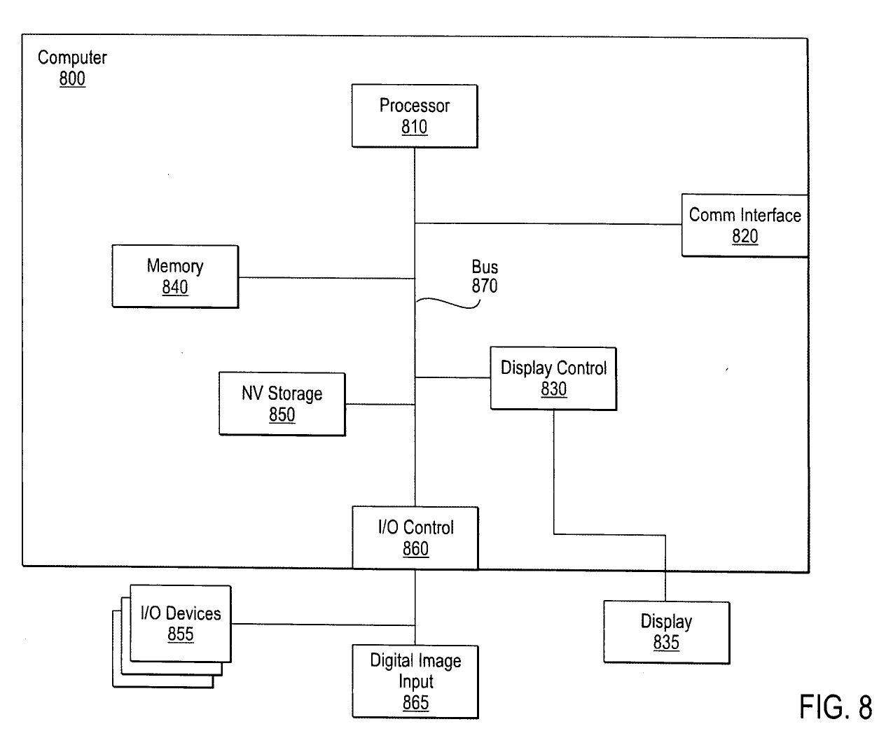

The following description of FIGS. 7-8 is intended to provide an overview of computer hardware and other operating components suitable for performing the methods of the invention described above and hereafter, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet. The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 740, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a conventional computer system that can be used as a client computer system or a server computer system or as a web server system. Such a computer system can be used to perform many of the functions of an internet service provider, such as ISP 710. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems.

The computer system 800 includes a processor 810, which can be a conventional microprocessor such as an Intel pentium microprocessor or Motorola power PC microprocessor. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an i/o controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

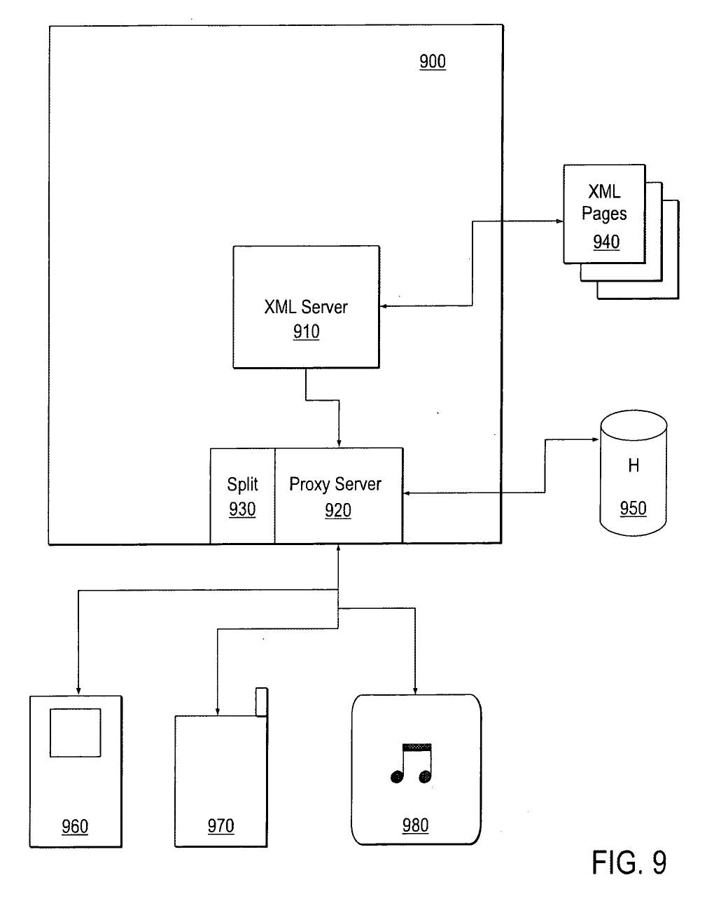

The various systems and methods may be implemented as a general purpose system operating in response to instructions embodied in a medium, such that systems 200 or 800 may work with a medium to implement process 300 or 400, for example. FIG. 9 illustrates an embodiment of a system or medium for segmenting a web page. Medium 900 represents a machine-readable medium or multiple machine-readable media. Medium 900 includes an XML or web server, a proxy server, a split module, and interfaces as may be needed. Thus, medium 900 may be employed with various systems. Moreover, medium 900 may be subdivided or integrated in various embodiments.

Medium 900 includes web server 910, which may be a web server, or may simply be an interface to a repository 940 of web pages. Repository 940 may be a hardwired location, or a variable location set for specific embodiments or instances for example. Proxy server 920 is a proxy server adapted to receive web pages from web server 910 (potentially responsive to a proxy server request), work with split module 930 to split web pages, retrieve device data from repository 950, serve portions of web pages to target devices and receive data from those target devices.

Split module 930 is a module dedicated to weighting content and splitting web pages into segments and/or portions in one embodiment. Split module may communicate with repository 950 in some embodiments (rather than proxy server 920). Repository 950 contain heuristics or specifications for use in device independent segmentation or device dependent segmentation and splitting into portions. Various devices which may act as target devices are illustrated, including personal digital assistant 960, cellular telephone 970 and digital music device 980 for example. Thus, a system may use medium 900 to implement a method in which a processor executes instructions from medium 900, and thereby directs the system to receive web pages, weight and/or split web pages, serve portions of web pages to a target device, receive data from the target device corresponding to the portions of web pages, bundle data, and transfer data, for example.

One skilled in the art will appreciate that although specific examples and embodiments of the system and methods have been described for purposes of illustration, various modifications can be made without deviating from the spirit and scope of the present invention. For example, embodiments of the present invention may be applied to many different types of databases, systems and application programs. Moreover, features of one embodiment may be incorporated into other embodiments, even where those features are not described together in a single embodiment within the present document. Accordingly, the invention is described by the appended claims.

What is claimed is:

1. A method, comprising:
receiving a request for a web page from a device having a small display;
splitting the web page into sections at a server, the sections both displayable by the device and transmittable in one transmission to the device; and
serving a first section of the web page to the device having the small display.

2. The method of claim 1, further comprising:
serving a second section of the web page.

3. The method of claim 1, further comprising:
weighting content of the web page.

4. The method of claim 3, wherein:
content is weighted based on a heuristic.

5. The method of claim 3, wherein:
content is weighted based on a profile for a target device.

6. The method of claim 5, wherein:
the profile for the target device is supplied by a manufacturer.

7. The method of claim 3, wherein:
content is weighted based on information from a target device.

8. The method of claim 7, further comprising:
querying the target device for information.

9. The method of claim 1, wherein:
the first section of the web page includes sticky content for use with all sections of the web page.

10. The method of claim 1, further comprising:
receiving data from a target device.

11. The method of claim 10, further comprising:
storing data from the target device as aggregate data.

12. The method of claim 11, further comprising:
transmitting aggregate data from the target device.

13. The method of claim 1, further comprising:
weighting content of the web page based on an expected display size of data of the web page.

14. A method of processing web data on a small device, comprising:
receiving a section of a web page from a server, the section sized to be both displayable on the small device and transmittable in one transmission to the small device; and
displaying the section of the web page on a small display of the small device.

15. The method of claim 14, further comprising:
querying for a next section of the web page.

16. The method of claim 14, further comprising:
querying for a next web page.

17. The method of claim 14, further comprising:
receiving data from a user responsive to the web page; and
transmitting the data to the server.

18. The method of claim 14, wherein:
the method is executed by a processor responsive to instructions, the instructions embodied in a machine-readable medium.

19. A system, comprising:
a page weighting module, the page weighting module to weight content of a web page;
a page splitting module, the page splitting module to split the web page based on display limits and transmission limits of a small device; and
a proxy server.

20. The system of claim 19, further comprising:
means for serving web pages to a proxy server.
